(19) United States
(12) Patent Application Publication
(10) Pub. No.: US 2024/0141520 A1
(43) Pub. Date: May 2, 2024

(54) MEMBRANE-ELECTRODE ASSEMBLY FOR POLYMER ELECTROLYTE WATER ELECTROLYSIS STACK AND MANUFACTURING METHOD THEREFOR

(71) Applicants: WESPE CO., LTD, Bongdong-eup (KR); CS HYDROGEN CO. LTD., Seoul (KR)

(72) Inventor: Hong Youl KIM, Goyang-si (KR)

(73) Assignees: WESPE CO., LTD, Seoul (KR); CS HYDROGEN CO. LTD., Seoul (KR)

(21) Appl. No.: 18/546,656

(22) PCT Filed: Jan. 13, 2022
(86) PCT No.: PCT/KR2022/000616

§ 371 Date: Aug. 16, 2023

(30) Foreign Application Priority Data
Feb. 16, 2021 (KR) 10-2021-0020379

(51) Int. Cl. C25B 11/095; C25B 1/04; C25B 11/052; C25B 11/097

(52) U.S. Cl. CPC C25B 11/095; C25B 11/052; C25B 11/097; C25B 1/04

(57) ABSTRACT

The present invention relates to a membrane-electrode assembly applied to a polymer electrolyte water electrolysis device (or system) that generates hydrogen and oxygen by electrolysis of pure water and to a polymer electrolyte water electrolysis stack comprising same. The present invention can accelerate entry into a hydrogen economy society by optimizing the compositions of an anode catalyst layer and a cathode catalyst layer among constituent elements of the membrane-electrode assembly to minimize the amount of a catalyst in the catalyst layers and reducing the power consumption to lower the production cost of hydrogen.

### FIELD OF THE DISCLOSURE

The present invention relates to a membrane-electrode assembly that is applied to a polymer electrolyte water electrolysis device that generates hydrogen and oxygen by the electrolysis of pure water, and a polymer electrolyte water electrolysis stack including the same.

### DESCRIPTION OF RELATED ART

The hydrogen-centered energy conversion system, which is expressed as a hydrogen economy, is considered as an important alternative to the environmental problems and energy depletion problems that are constantly generated and accumulated in the existing fossil fuel system. The ultimate energy source in the hydrogen economy will be renewable energy such as solar power or wind power, and in order to compensate for the intermittency thereof, some of this power needs to be stored as hydrogen energy through water electrolysis. Stored hydrogen is again converted into electric power through distributed power generation, charging for transportation and the like, and separately, the demand for hydrogen for chemical reactions, direct combustion and the like is steadily increasing.

In recent years, particularly, the widespread installation of hydrogen charging stations has become an urgent need due to the spread of hydrogen vehicles, which are the main prospects for eco-friendly vehicles, and moreover, the selling price of hydrogen has also become a major concern. Therefore, we are studying in depth not only domestically but also globally on how to manufacture hydrogen economically and environmentally. However, due to the inadequacy of technology and economic feasibility, the method of obtaining fossil fuels such as methane gas and the like by steam reforming and then purifying and using the same, which is the conventional hydrogen production method, has been mainly used, and the true meaning of the hydrogen economy has not been realized. Currently, the consensus around the world is that the method of using the electrolysis of water has been considered as a viable alternative that can be eco-friendly and economically feasible in the shortest possible time.

As a method of obtaining hydrogen by the electrolysis of water, alkaline water electrolysis is a representative method, but this method has many disadvantages. Hydrogen obtained by the electrolysis of alkaline water has low purity and requires purification, and the electrolyte in aqueous solution requires continuous management, and there is also a problem of device corrosion. In terms of performance, since the current density is not high, the efficiency is low compared to the size of the device, and the voltage at constant current is relatively high, which results in high power consumption.

On the other hand, the polymer electrolyte water electrolysis, which has been in the spotlight recently, compensates for most of the disadvantages of the electrolysis of alkaline water. Since hydrogen obtained by the water electrolysis of a polymer electrolyte has almost no impurities other than a small amount of water, there is no need for purification, and since the electrolyte is in a solid state, management is unnecessary, and since pure water is used, there is no problem of device corrosion. In terms of efficiency, the current density is high, and the power consumption is low. In addition, the electrolysis of water occurs well even at high pressure, which has the advantage of producing high-pressure hydrogen without a compression device.

However, the polymer electrolyte water electrolysis device has a disadvantage in that it is difficult to enter the market due to the high device price compared to other devices, and particularly, the initial device introduction cost is a major obstacle for application to large-capacity hydrogen generation. This is because the price of the water electrolysis stack, which is a key component, is high, because the polymer electrolyte membrane is strongly acidic, and the materials that can be used are limited to expensive materials because of the high oxidation potential and oxygen atmosphere of the anode. The material that occupies the largest cost among the components of the stack is a bipolar plate, and generally, a titanium material is used, and although the material itself is expensive, the cost of processing a flow path is much higher. Next, the prices of the noble metal catalyst, the polymer electrolyte membrane and the porous moving layer, which are components of the membrane-electrode assembly, are also high.

The titanium bipolar plate, which occupies the largest cost in the polymer electrolyte water electrolysis stack, achieves a very large economic effect by eliminating the cost of flow path processing through the polymer electrolyte water electrolysis device using a three-dimensional mesh as described in Korean Registered Patent No. 10-1198220. At the same time, in terms of performance and durability, it has shown equal or better results than the bipolar plate formed with a flow path, which sends a green light to the market entry of the polymer electrolyte water electrolysis device.

The polymer electrolyte water electrolysis stack can exhibit optimal performance by physicochemical harmony between the membrane-electrode assembly where the reaction takes place and the bipolar plate supporting the same. This is because electrochemical reactions and physical phenomena such as the diffusion and movement of substances occur simultaneously inside the cell and mutually influence each other. Therefore, these two parts are generally developed independently of each other, but in order to obtain the optimal stack performance, they can be achieved through a common optimization conclusion in which physicochemical phenomena can be harmonized with each other.

Therefore, in order to use the bipolar plate using a three-dimensional mesh in the best state, which has showed excellent results in performance and durability as well as economic performance, the membrane-electrode assembly must have a structure optimized for the three-dimensional mesh. Among these, the structure of a catalyst layer in which the electrochemical reaction takes place is closely related to the distribution of power supply and the distribution of fluid passages that are unique to the three-dimensional mesh, and thus, it is necessary to optimize this first. In addition, since the noble metal material used as the catalyst is an expensive material as described above, it must be used in a minimum amount within the limit to ensure performance, particularly, durability. Therefore, there is a need to determine the composition and loading amount of a catalyst layer that is optimized for a water electrolysis stack by using a three-dimensional mesh for the performance, durability and cost reduction of a polymer electrolyte stack.

### SUMMARY

The present invention is directed to providing a catalyst layer of a membrane-electrode assembly that is optimized for a configuration using a three-dimensional mesh as a flow path and a current collector in a polymer electrolyte water electrolysis stack as described above, a membrane-electrode assembly constituting the catalyst layer and a manufacturing method therefor.

In order to achieve the above object, the present invention provides a membrane-electrode assembly for a polymer electrolyte water electrolysis stack, wherein an anode electrode layer, an anode catalyst layer, a polymer solid electrolyte membrane, a cathode catalyst layer and a cathode electrode layer are sequentially stacked, wherein the anode catalyst layer may include a mixed catalyst comprising iridium and ruthenium at 0.50 to 0.90 mg/cm², and wherein the cathode catalyst layer may include platinum at 0.06 to 0.10 mg/cm².

In a preferred exemplary embodiment of the present invention, the anode catalyst layer may be coated on one surface of the polymer solid electrolyte membrane or one surface of the anode electrode layer, and the cathode catalyst layer may be coated on one surface of the polymer solid electrolyte membrane or one surface of the cathode electrode layer.

In a preferred exemplary embodiment of the present invention, the anode catalyst layer may include iridium and ruthenium at a weight ratio of 1:0.40 to 2.40.

In a preferred exemplary embodiment of the present invention, in the polymer electrolyte water electrolysis stack, a flow path plate including a three-dimensional mesh may be stacked on one surface of each of the anode electrode layer and the cathode electrode layer.

In addition, the present invention relates to a method for manufacturing a membrane-electrode assembly for a polymer electrolyte water electrolysis stack (Manufacturing Method 1), and a process including step 1 of bonding a film for forming an anode catalyst layer to one surface of a polymer electrolyte membrane and bonding a film for forming a cathode catalyst layer to the other surface of the polymer electrolyte membrane; step 2 of performing a pressing process under the conditions of 130 to 145° C. and 130 to 150 bar for the polymer electrolyte membrane performed in step 1 to transfer an anode catalyst layer to one surface of the polymer electrolyte membrane and transfer a cathode catalyst layer to the other surface of the polymer electrolyte membrane; step 3 of removing release films on both surfaces from the polymer electrolyte membrane performed in step 2 to manufacture an assembly in which an anode catalyst layer, a polymer electrolyte membrane and a cathode catalyst layer are sequentially stacked; and step 4 of respectively bonding electrodes to the upper portion of the anode catalyst layer and the upper portion of the cathode catalyst layer of the assembly, and then performing a pressing process may be performed.

In a preferred exemplary embodiment of the present invention, the film for forming an anode catalyst layer in step 1 may be prepared by coating an anode catalyst ink on one surface of a release film, and then performing a first heat treatment at 95 to 110° C. for 50 to 120 minutes, followed by a second heat treatment at 120 to 140° C. for 20 to 40 minutes.

In a preferred exemplary embodiment of the present invention, the anode catalyst ink may include 10 to 35 parts by weight of an ionomer and 4,500 to 5,500 parts by weight of a solvent, based on 100 parts by weight of a mixed powder comprising iridium powder and ruthenium powder.

In a preferred exemplary embodiment of the present invention, the mixed powder may include iridium and ruthenium at a weight ratio of 1:0.40 to 2.40.

In a preferred exemplary embodiment of the present invention, the film for forming a cathode catalyst layer in step 1 may be prepared by coating a cathode catalyst ink on one surface of a release film, and then performing a first heat treatment at 95 to 110° C. for 50 to 120 minutes, followed by a second heat treatment at 120 to 140° C. for 20 to 40 minutes.

In a preferred exemplary embodiment of the present invention, the cathode catalyst ink may include 35 to 80 parts by weight of an ionomer and 4,500 to 5,500 parts by weight of a solvent, based on 100 parts by weight of amorphous carbon black comprising 15 to 25 wt. % of platinum.

In a preferred exemplary embodiment of the present invention, the solvent of the anode catalyst ink and/or cathode catalyst ink may include distilled water and isopropanol.

In a preferred exemplary embodiment of the present invention, the anode catalyst layer in step 3 may include a mixed catalyst including iridium and ruthenium at 0.50 to 0.90 mg/cm², and the cathode catalyst layer may include platinum at 0.06 to 0.10 mg/cm².

In addition, the present invention relates to another method for manufacturing a membrane-electrode assembly for a polymer electrolyte water electrolysis stack (Manufacturing Method 2), wherein after respectively preparing an anode electrode formed with an anode catalyst layer and a cathode electrode formed with a cathode catalyst layer, a process of respectively stacking and bonding the anode electrode and the cathode electrode to one surface of a polymer electrolyte membrane may be performed,

In a preferred exemplary embodiment of the present invention, the anode electrode of Manufacturing Method 2 may be prepared by applying an anode catalyst ink on one surface of the electrode and then performing heat treatment, and the cathode electrode may be prepared by applying a cathode catalyst ink on one surface of the electrode and then performing heat treatment.

In a preferred exemplary embodiment of the present invention, the anode catalyst layer of Manufacturing Method 2 may include a mixed catalyst comprising iridium and ruthenium at 0.50 to 0.90 mg/cm², and the cathode catalyst layer may include platinum at 0.06 to 0.10 mg/cm².

In a preferred exemplary embodiment of the present invention, the anode catalyst ink and cathode catalyst ink of Manufacturing Method 2 may be the same as the anode catalyst ink and cathode catalyst ink of Manufacturing Method 1.

In addition, the present invention relates to a polymer electrolyte water electrolysis device, which may be configured by a polymer electrolyte water electrolysis stack including a plurality of the above-described membrane-electrode assembly, a gasket and an end plate, and in the polymer electrolyte water electrolysis stack, a flow path plate including a three-dimensional mesh may be stacked on one surface of each of the anode electrode layer and the cathode electrode layer of the membrane-electrode assembly.

The catalyst layer that is optimized for the polymer electrolyte water electrolysis stack using a three-dimensional mesh according to the present invention adds high water electrolysis stack efficiency and durability to the economic performance obtained by using the existing three-dimensional mesh as a flow path and current collector, and by maximizing the economic effect by greatly reducing the content of precious metal catalysts used in the anode and/or cathode catalyst layer, the high device price, which is the biggest obstacle to the polymer electrolyte water electrolysis device, is eliminated, and by reducing the power consumption to lower the production cost of hydrogen, it is possible to accelerate entry into the hydrogen economy society.

### BRIEF DESCRIPTION OF THE DRAWINGS

FIG. 1 is a photograph showing the method for manufacturing a membrane-electrode assembly according to an exemplary embodiment of the present invention.

FIG. 2 is a photograph showing the method for manufacturing a polymer electrolyte water electrolysis stack using a three-dimensional mesh according to an exemplary embodiment of the present invention.

FIG. 3 shows the test device for a polymer electrolyte water electrolysis stack using a three-dimensional mesh according to an exemplary embodiment of the present invention.

FIG. 4 shows the performance and durability test measurement results of Examples 1 to 4 of the present invention.

FIG. 5 shows the performance and durability test measurement results of Examples 5 to 8 of the present invention.

FIG. 6 shows the performance and durability test measurement results of Examples 9 to 12 of the present invention.

FIG. 7 shows the performance and durability test measurement results of Examples 13 to 16 of the present invention.

FIG. 8 shows the performance and durability test measurement results of Examples 17 to 20 of the present invention.

FIG. 9 shows the performance and durability test measurement results of Examples 21 to 24 of the present invention.

### DETAILED DESCRIPTION OF THE DRAWINGS

The terms or words used in the present specification and the claims should not be interpreted as being limited to common and dictionary meanings. On the contrary, they should be interpreted based on the meanings and concepts of the invention in compliance with the scope of the invention on the basis of the principle that the inventor(s) can appropriately define the terms in order to describe the invention in the best way.

The present invention relates to a membrane-electrode assembly (hereinafter, referred to as MEA) constituting a stack of a polymer electrolyte device that is applied to a polymer electrolyte water electrolysis device or system that electrolyzes water to generate hydrogen and oxygen.

The polymer electrolyte water electrolysis device or system may be a generally known polymer electrolyte water electrolysis device or system, and as a preferred example, it may be a polymer electrolyte water electrolysis device (or system) using a flow path plate including a three-dimensional mesh as disclosed in Korean Registered Patent No. 10-1198220.

In the membrane-electrode assembly (MEA) of the present invention, an anode electrode layer, an anode catalyst layer, a polymer solid electrolyte membrane, a cathode catalyst layer and a cathode electrode layer are sequentially stacked.

The anode catalyst layer is coated on one surface of the polymer solid electrolyte membrane or one surface of the anode electrode layer, and the anode catalyst layer includes a mixed catalyst including iridium and ruthenium at 0.50 to 0.90 mg/cm², and preferably, it may include at 0.55 to 0.70 mg/cm², and more preferably, 0.55 to 0.65 mg/cm². In this case, if the content of the mixed catalyst in the anode catalyst layer is less than 0.50 mg/cm² or is more than 0.90 mg/cm², there may be a problem in that the amount of power consumption increases due to the performance deterioration of the catalyst layer or the effect of generating hydrogen is reduced.

In addition, it is advantageous in terms of minimizing the power consumption of a water electrolysis device, the water electrolysis operation efficiency and the long-term stability of performance and durability, when the mixed catalyst includes iridium (Ir) and ruthenium (Ru) at a weight ratio of 1:0.40 to 2.40, preferably includes iridium and ruthenium at weight ratio of 1:0.80 to 1.90, more preferably includes iridium and ruthenium at a weight ratio of 1:1.00 to 1.50, and still more preferably includes at a weight ratio of 1:1.10 to 1.40.

In addition, the cathode catalyst layer is coated on one surface of the polymer solid electrolyte membrane or one surface of the cathode electrode layer, and the cathode catalyst layer includes platinum (Pt) at 0.06 to 0.10 mg/cm², preferably includes platinum at 0.065 to 0.090 mg/cm², and more preferably includes platinum at 0.070 to 0.085 mg/cm². In this case, if the content of platinum in the cathode catalyst layer is less than 0.06 mg/cm² or is more than 0.10 mg/cm², there may be a problem in that the power consumption of the water electrolysis device increases, and thus, it is recommended to use it within the above range.

The present invention may provide a polymer electrolyte water electrolysis stack including one or a plurality of stacks in which a flow path plate including a three-dimensional mesh is stacked on one surface of each of the anode electrode layer and the cathode electrode layer of the MEA.

The flow path plate is configured in a structure where a three-dimensional mesh and a planar separator are combined, and the three-dimensional mesh operates as a flow path. In addition, each unit mesh of the three-dimensional mesh has a diamond shape, and in the diamond shape, the short diagonal length of the diamond shape may be 1.4 to 2.0 mm, the long diagonal length of the diamond shape may be 1.8 to 3.0 mm, the mesh line thickness of the unit mesh may be 0.2 to 0.3 mm, and the thickness of the three-dimensional mesh may be 0.5 to 0.8 mm.

In addition, the three-dimensional mesh may be made of titanium, and when using other metal materials that may cause corrosion, it is also possible to treat the surface with a material such as gold, platinum, iridium, titanium or the like.

In terms of a flow path plate, the three-dimensional mesh is intended to replace the one used as the flow path plate by forming a flow path in the separation plate, and it is possible to reduce the cost of forming a flow path by combining with the separation plate to be used without the need to separately form the flow path through the mesh.

The MEA of the present invention described above may be manufactured by two methods. Manufacturing Method 1 is a method of forming an anode catalyst layer and a cathode catalyst layer on both surfaces of a polymer electrolyte membrane, and then stacking and integrating electrodes, and Manufacturing Method 2 is a method in which an anode catalyst layer and a cathode catalyst layer are respectively formed on an electrode, and then stacked and integrated on both surfaces of a polymer electrolyte membrane.

When Manufacturing Method 1 is specifically described, a process including step 1 of bonding a film for forming an anode catalyst layer to one surface of a polymer electrolyte membrane and bonding a film for forming a cathode catalyst layer to the other surface of the polymer electrolyte membrane; step 2 of performing a pressing process for the polymer electrolyte membrane performed in step 1 to transfer an anode catalyst layer to one surface of the polymer electrolyte membrane and transfer a cathode catalyst layer to the other surface of the polymer electrolyte membrane; step 3 of removing release films on both surfaces from the polymer electrolyte membrane performed in step 2 to manufacture an assembly in which an anode catalyst layer, a polymer electrolyte membrane and a cathode catalyst layer are sequentially stacked; and step 4 of respectively bonding electrodes to the upper portion of the anode catalyst layer and the upper portion of the cathode catalyst layer of the assembly, and then performing a pressing process is performed.

In Manufacturing Method 1, the film for forming an anode catalyst layer in step 1 may be prepared by coating an anode catalyst ink on one surface of the release film, and then performing a first heat treatment at 95 to 110° C. for 50 to 120 minutes, followed by a second heat treatment at 120 to 140° C. for 20 to 40 minutes.

In addition, the anode catalyst ink may include 10 to 35 parts by weight of an ionomer and 4,500 to 5,500 parts by weight of a solvent, based on 100 parts by weight of the mixed powder including iridium powder and ruthenium powder, preferably include 12.5 to 28.0 parts by weight of an ionomer and 4,700 to 5,300 parts by weight of a solvent, based on 100 parts by weight of the mixed powder, and more preferably include 14.0 to 25.0 parts by weight of an ionomer and 4,800 to 5,200 parts by weight of a solvent, based on 100 parts by weight of the mixed powder. In this case, if the amount of ionomer used in the anode catalyst ink is less than 10 parts by weight, the triple phase boundary area is reduced and a catalyst that cannot be used for the water electrolysis reaction may be generated such that the performance of the stack may not be sufficiently expressed, and if used in excess of 30 parts by weight, the reaction surface area of the catalyst is reduced or electrical conductivity is reduced, and the flow of the fluid is disturbed such that the performance of the membrane-electrode assembly may be rather deteriorated, and thus, it is preferable to use it within the above range.

In addition, the mixed powder may include iridium and ruthenium at a weight ratio of 1:0.40 to 2.40, preferably, at a weight ratio of 1:0.80 to 1.90, more preferably, at a weight ratio of 1:1.00 to 1.50, and still more preferably, at a weight ratio of 1:1.10 to 1.40. In this case, if the weight ratio of ruthenium is less than a weight ratio of 0.4, there may be a problem of poor MEA performance, and if the weight ratio of ruthenium is more than a weight ratio of 2.40, there may be a problem in that the long-term performance and durability of the MEA may be deteriorated, and thus, it is preferable to use it within the above range.

In Manufacturing Method 1, the film for forming a cathode catalyst layer in step 1 may be prepared by coating a cathode catalyst ink on one surface of the release film, and then performing a first heat treatment at 95 to 110° C. for 50 to 120 minutes, followed by a second heat treatment at 120 to 140° C. for 20 to 40 minutes.

In addition, the cathode catalyst ink may include 35 to 80 parts by weight of an ionomer and 4,500 to 5,500 parts by weight of a solvent, based on 100 parts by weight of amorphous carbon black including platinum, preferably include 42 to 75 parts by weight of an ionomer and 4,700 to 5,350 parts by weight of a solvent, based on 100 parts by weight of amorphous carbon black including platinum, and more preferably include 45 to 70 parts by weight of an ionomer and 4,800 to 5,250 parts by weight of a solvent, based on 100 parts by weight of the amorphous carbon black including platinum. In this case, if the amount of the ionomer used in the cathode catalyst ink is less than 35 parts by weight, the triple phase boundary area is reduced and a catalyst that cannot be used for the water electrolysis reaction may be generated such that the performance of a water electrolysis stack in which the membrane-electrode assembly of the present invention is introduced may not be sufficiently expressed, and if used in excess of 80 parts by weight, the reaction surface area of the catalyst is reduced or electrical conductivity is reduced, and the flow of the fluid is disturbed such that the performance of the membrane-electrode assembly may be rather deteriorated, and thus, it is preferable to use it within the above range.

In addition, the amorphous carbon black may include 15 to 25 wt. % of platinum, and preferably include 17.5 to 22.5 wt. % of platinum.

The ionomer used in the preparation of the anode catalyst ink and/or the cathode catalyst ink may be an ionomer generally used in the art, and a preferred example may include a fluorocarbon-based ionomer such as Nafion and the like.

The solvent used for preparing the anode catalyst ink and/or cathode catalyst ink may include distilled water and isopropanol at a volume ratio of 1:0.5 to 2.0, and preferably include distilled water and isopropanol at a volume ratio of 1:0.75 to 1.65.

In addition, the release film is a release film made of a heat-resistant resin, and may be, for example, a polyimide film.

In addition, when each of the anode and/or cathode catalyst ink is coated on the release film, it must be considered that the coating amount of the catalyst ink must be adjusted in consideration of the amount of catalyst that goes out or scatters during spraying such that the contents of catalysts in the anode catalyst layer and/or cathode catalyst layer to be prepared can be matched.

In Manufacturing Method 1, the pressing of step 2 may be performed under the conditions of 130 to 145° C. and 130 to 150 bar, and preferably, under the conditions of 135 to 145° C. and 135 to 145 bar.

The electrode of step 4 may use a porous paper, and as a preferred example thereof, porous carbon paper, porous titanium paper and the like may be used as a porous transport layer (PTL).

In addition, the pressing of step 4 may be performed under the conditions of 120 to 140° C. and 80 to 120 bar, and preferably, under the conditions of 120 to 135° C. and 90 to 110 bar.

By performing the four-step process of Manufacturing Method 1, an anode electrode layer, an anode catalyst layer, a polymer solid electrolyte membrane, a cathode catalyst layer and a cathode electrode layer are sequentially stacked to manufacture an integrated membrane-electrode assembly (MEA).

Further, in Manufacturing Method 2 above, a process of respectively preparing an anode electrode formed with an anode catalyst layer and a cathode electrode formed with a cathode catalyst layer, and then respectively stacking and bonding the anode and cathode electrodes to one surface of a polymer electrolyte membrane may be performed.

The electrode used to form the anode electrode and/or the cathode electrode may use a porous paper, and as a preferred example thereof, a porous carbon paper, porous titanium paper and the like may be used as a porous transport layer (PTL).

Next, after respectively coating the anode catalyst ink or the cathode catalyst ink on one surface of the electrode, the first heat treatment may be performed at 95 to 110° C. for 50 to 120 minutes, and then, the second heat treatment may be performed at 120 to 140° C. for 20 to 40 minutes to prepare an anode electrode and/or a cathode electrode, respectively.

In addition, the anode catalyst ink and the cathode catalyst ink of Manufacturing Method 2 are the same as those described in Manufacturing Method 1.

In addition, each of the prepared anode and cathode electrodes is stacked on one surface of the polymer electrolyte membrane, and then a pressing process may be performed to combine or integrate the same to manufacture an MEA.

As described above, in the anode catalyst layer and/or the cathode catalyst layer of the MEA manufactured in Manufacturing Method 1 and Manufacturing Method 2, the anode catalyst layer may include a mixed catalyst including iridium and ruthenium at 0.50 to 0.90 mg/cm², and the cathode catalyst layer may include platinum at 0.06 to 0.10 mg/cm².

In addition, a polymer electrolyte membrane stack may be manufactured by stacking and integrating the flow path plates including a three-dimensional mesh on one surface and the other surface of the MEA manufactured in Manufacturing Method 1 or Manufacturing Method 2, respectively, and a stack may also be manufactured by stacking and integrating a plurality of the stacks.

Hereinafter, the present invention will be described in more detail through examples. However, the following examples are not intended to limit the scope of the present invention, which should be construed to aid the understanding of the present invention.

### EXAMPLES

### Examples 1 to 8: Manufacture of MEA

### (1) Preparation of Anode Catalyst Ink and Film for Forming Anode Catalyst Layer

Mixed powders were respectively prepared by using iridium powder, ruthenium powder and/or platinum powder at the composition ratios shown in Table 1 below.

Based on 100 parts by weight of the mixed powder, 17.65 parts by weight of a fluorine-based ionomer (Manufacturer: DuPont, Product Name: D 520) and 5,000 parts by weight of the remaining solvent (including distilled water and isopropanol at a volume ratio of 1:1) were mixed, followed by mixing by ultrasonication for 24 hours to prepare an anode catalyst ink.

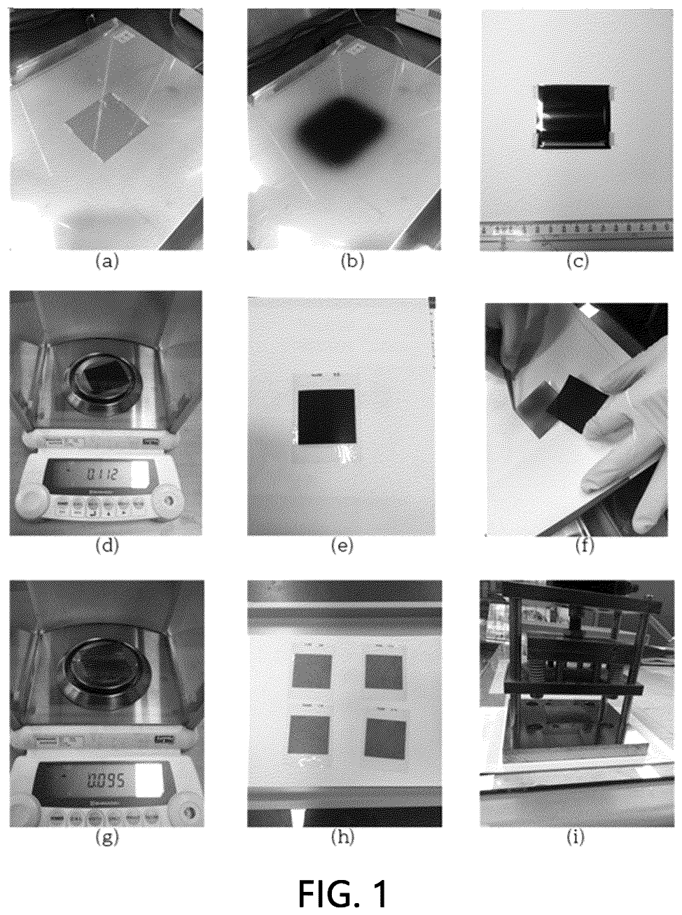

Next, after spraying the anode catalyst ink on a polyimide film (FIG. 1-a) which has a width and length of 60 mm and 55 mm, and a thickness of 0.02 mm and was fixed on a hot plate (FIG. 1-b), it was sprayed on the top such that the ionomer was 0.6 mg/cm².

Next, the sprayed film was placed in an oven, heat treated at 100° C. for 1 hour and at 130° C. for 30 minutes, then cut to be 50 mm wide and 50 mm long (FIG. 1-c), respectively, and the weight was measured (FIG. 1-d) to prepare a film for forming an anode catalyst layer.

### (2) Preparation of Cathode Catalyst Ink and Film for Forming Cathode Catalyst Layer

Amorphous carbon black (Pt/C) including 20 wt. % of platinum was purchased and prepared.

Based on 100 parts by weight of the Pt/C, a cathode catalyst ink was prepared by mixing 50 parts by weight of a fluorine-based ionomer (Manufacturer: DuPont, Product Name: D 520) and 5,000 parts by weight of the remaining solvent (including distilled water and isopropanol at a volume ratio of 1:1), followed by mixing by ultrasonication for 24 hours.

Next, after spraying the cathode catalyst ink on a polyimide film which has a width and length of 60 mm and 55 mm, and a thickness of 0.02 mm and was fixed on a hot plate, it was sprayed on the top such that the ionomer was 0.6 mg/cm². In this case, the amount of spraying of the catalyst ink was performed by spraying 1.5 times the loading amount of the catalyst layer.

Next, the sprayed film was placed in an oven, heat treated at 100° C. for 1 hour, and at 130° C. for 30 minutes, then cut to be 50 mm wide and 50 mm long, respectively, and the weight was measured to prepare the film for forming a cathode catalyst layer.

### (3) Formation of Anode Catalyst Layer and Cathode Catalyst Layer

After placing the film for forming a cathode catalyst layer on a hot press plate and placing a pretreated polymer electrolyte membrane (Nafion 115) thereon, the film for forming an anode catalyst layer was placed thereon so as to face between the cathode catalyst layer and the anode catalyst layer, and pressing was performed for 2 minutes under the temperature and pressure conditions of 137° C. and 140 bar, and after turning the press plate 180 degrees, pressing was performed again for 2 minutes.

Next, after removing the polyimide film from the assembly (FIG. 1-e) to which the polyimide film, which is the release film, was attached to both sides (FIG. 1-f) to obtain the assembly and weighing the removed release film (FIG. 1-g), the amount of the catalyst layer that was transferred to the polymer electrolyte membrane was calculated by the difference with the weight of the film for forming a cathode or anode catalyst layer.

The transfer rate was calculated as the difference between the weight of the film after transfer and the weight of 95 mg of the original film 25 cm². All the transcribed amounts were confirmed to be 95 to 100%.

### (4) Manufacture of MEA and Manufacture of MEA Stack

A final membrane-electrode assembly (hereinafter, referred to as MEA) was fabricated by applying a porous titanium paper (hereinafter, referred to as PTL) to both sides of the assembly and performing hot pressing for 2 minutes at 130° C. and 100 bar (FIG. 1-h).

Next, the flow path and guide pin position of the stack at the upper and lower positions of the MEA membrane were punched (FIG. 1-i).

TABLE 1

| | Anode catalyst layer | | Cathode catalyst layer | |
|---|---|---|---|---|
| | | Content in | | Content in |
| | Type of | catalyst layer | | catalyst layer |
| | | (or loading | Type of | (or loading |
| | catalyst in | amount, | catalyst in | amount, |
| Example | catalyst layer | mg/cm²) | catalyst layer | mg/cm²) |
| 1 | Ir | 0.7 | Pt/C | Content of |
| 2 | (100 wt. %) | 0.9 | (100 wt. %) | platinum |
| 3 | Ir and Ru | 0.7 | | in catalyst |
| 4 | (Weight ratio | 0.9 | | layer = 0.1 |
| | of 1:1) | | | |
| 5 | Ir, Ru and Pt | 0.7 | | |
| 6 | (Weight ratio | 0.9 | | |
| 7 | of 1:1:1) | 0.7 | Ir, Ru and Pt | 0.7 |
| 8 | | 0.9 | (Weight ratio | 0.9 |
| | | | of 1:1:1) | |

### Experimental Example 1: Performance and Durability Test

The performance and durability test was performed at room temperature (about 25° C.) without heating at a current density of 50 A, that is, 2 A/cm² by assembling four MEAs manufactured in the above example as one stack as follows.

If the test is started at room temperature without heating, due to the characteristics of the test equipment, the voltage of the stack is high and heat is generated as much as the overvoltage, and the water temperature in the water tank increases, and accordingly, the voltage of the stack is lowered and a steady state is achieved at the offset of this temperature and overvoltage.

Whenever the water in the water tank is exhausted and refilled, the temperature decreases and then rises again, and the voltage was measured after the temperature became as close to the steady state as possible.

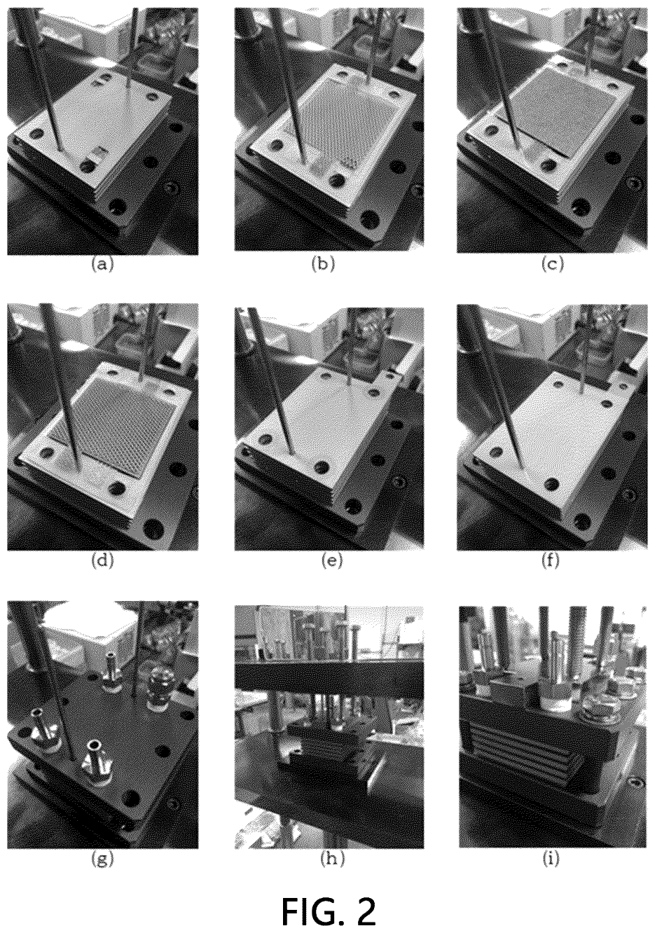

For the stack assembly, an end plate, an insulating film, a bipolar plate without a flow path formed, a three-dimensional mesh on the anode side, the MEA of Example 1, a three-dimensional mesh on the cathode side, a bipolar plate without a flow path formed, and again a three-dimensional mesh on the anode side and the MEA of Example 2 are assembled in this order on the assembly equipment. The assembly process thereof is shown in FIG. 2, and when it is described with reference to FIG. 2, the bipolar plate without a flow path formed (FIG. 2-a), the three-dimensional mesh on the anode side (FIG. 2-b), the MEA of the examples (FIG. 2-c), the three-dimensional mesh on the cathode side (FIG. 2-d), the bipolar plate without a flow path formed (FIG. 2-e), the insulating film (FIG. 2-f), and finally the end plate (FIG. 2-g) were placed thereon, and after aligning the horizontal and pressure of 120 bar (FIG. 2-h), the stack was completed by fastening with 6 bolts (FIG. 2-i).

Afterwards, all MEA tests were also conducted by assembling four MEAs into one stack, and the advantage of this method is that the current density and temperature conditions, which are the most important elements of the test, can be applied exactly the same to the four MEAs, and the duration of the durability tests to be performed over a long period of time can be shortened by 4 times compared to the case of performing one by one. As a disadvantage, the comparison between the four MEAs in the stack is very accurate, but the comparison of the MEAs between different stacks cannot be accurately compared with simple numerical values, and it can only be inferred by using a common, comparable MEA as much as possible. The main cause thereof is due to the difference in temperature conditions, and for example, in a stack including the MEA with poor performance (high voltage at a constant current), thermal energy due to high overvoltage from this MEA contributes to the temperature conditions of other MEAs such that it leads to better performance (lower voltage at constant current). Therefore, special attention is required in the comparison of MEA test results between stacks.

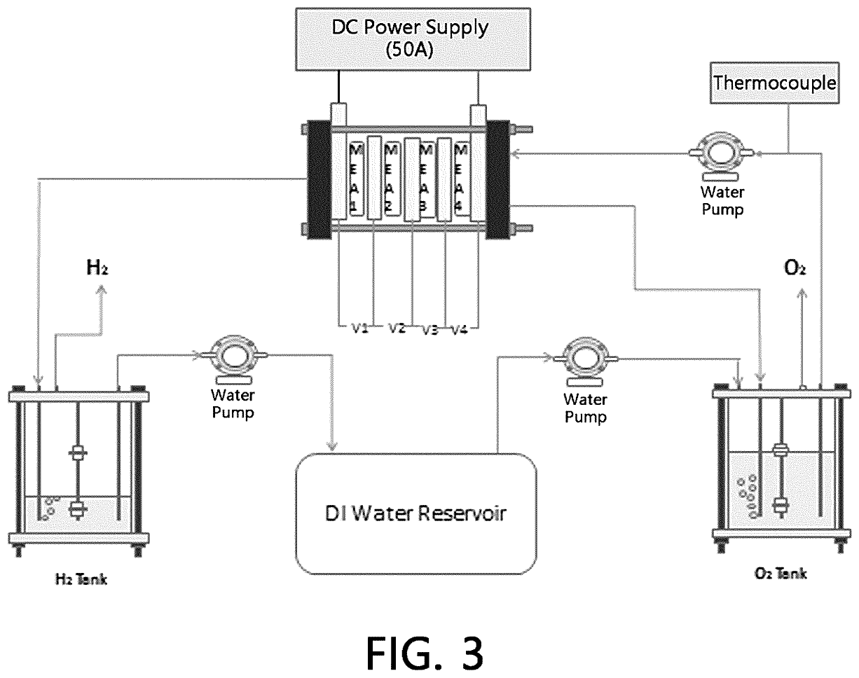

The test of the assembled stack was performed by supplying deionized water and DC power, as shown in FIG. 3. The deionized water is supplied to the anode (oxygen electrode) side, and the water temperature at this time is measured and recorded, and it is assumed that it is the same as the temperature of the stack, and excess water is returned to the oxygen-side water tank along with the generated oxygen. When the water level in the oxygen-side water tank is lowered due to consumption, a certain amount is replenished from the deionized water tank. At the cathode (hydrogen electrode), a small amount of water that has crossed by electric osmotic pressure along with the generated hydrogen enters the hydrogen-side water tank, and when the water level in the hydrogen-side water tank rises by a certain amount, it returns to the deionized water tank.

In the case of DC power supply, a current of 50 A was fixed and supplied to the 25 cm² electrode used in the experiment, because the experiment was to measure the change in voltage according to the operating time under the condition of a current density of 2 A/cm².

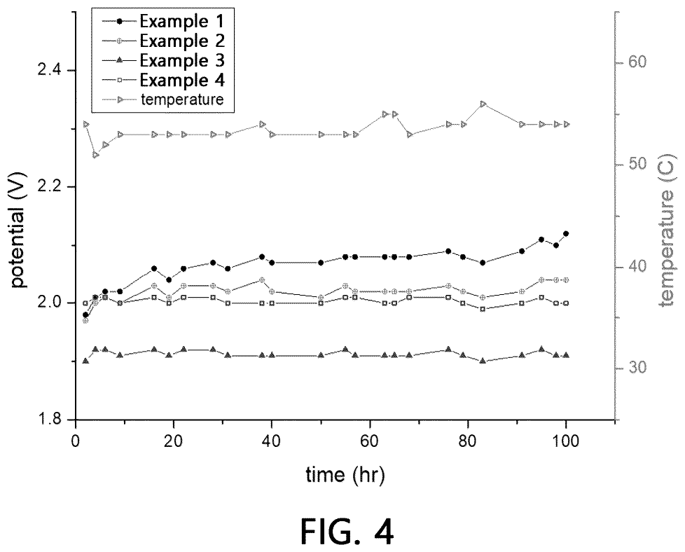

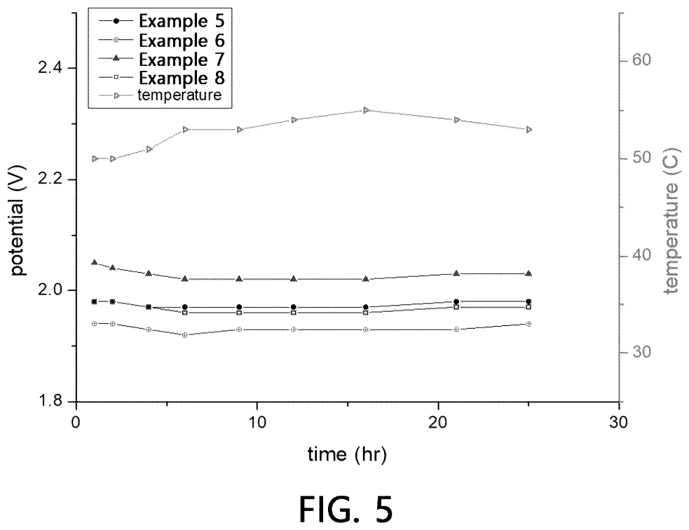

Since the experiment was conducted by assembling four MEAs into one stack, voltages V1, V2, V3, V4 that were applied to both ends of the bipolar plate supporting each MEA were measured, respectively, as in the stack of FIG. 3. The operation time of the stack was carried out for about 10 hours a day, and the temperature and voltages V1, V2, V3, V4 were recorded about 3 or 4 times, and basically, after performing the test for 100 hours, the results were analyzed, and the results are shown in FIGS. 4 and 5.

Referring to FIG. 4, it can be confirmed that the performance of the catalyst mixed with iridium and ruthenium (Examples 3 to 4) as catalysts of the anode catalyst layer was significantly better than that of the iridium-only catalyst (Examples 1 and 2). In particular, in the case of the iridium-only catalyst, the performance improved as the content (loading amount) in the catalyst layer increased, whereas the mixed catalyst of iridium and ruthenium showed better performance as the content (loading amount) in the catalyst layer decreased.

This is a very desirable result of improving performance and economic feasibility at the same time, and the composition and loading amount of Example 3 were set as the primary selected reference MEA.

The performance of polymer electrolyte water electrolysis depends on the rate of electrochemical reaction on the catalyst surface and the adsorption/desorption and movement speeds of reactants and products on the catalyst surface and in the space between the catalysts.

From the results of Examples 1 and 2, it can be seen that the performance of the iridium-only catalyst was improved when the content of catalyst was increased because the reaction rate on the surface was slow. On the other hand, in the results of Examples 3 and 4, the reaction rate of the mixed catalyst of iridium and ruthenium was very fast, and thus, it can be seen that the performance is improved by increasing the movement speeds of the materials by decreasing the content of the catalyst. Since this is a problem that is directly related not only to the structure of the catalyst layer itself, but also to the structure of a three-dimensional mesh that presses the catalyst layer as a result, it was confirmed that the optimization of the catalyst layer requires the development of a catalyst layer optimized for the three-dimensional mesh.

FIG. 5 is a graph showing the test results of Examples 5 to 8, and since the MEA, which can be used without distinction of an anode and a cathode, has various advantages, platinum, which is a catalyst for the cathode catalyst layer, was added to the mixed catalyst of iridium and ruthenium, which are catalysts for the anode catalyst layer, to test the catalysts for both electrodes.

In addition, the MEA using Pt/C as a cathode catalyst was also tested to observe the performance of the three-component mixed catalyst as an anode catalyst. There was an effect of improving the performance by increasing the content (loading amount) of catalyst in the catalyst layer, which appears to be the result of platinum failing to act as a catalyst at low overvoltage in the anode, and thus, the content of the effective catalyst was lowered by the mixing ratio.

The cathode catalyst layer also showed that the performance of the MEA (Examples 5 to 6) using Pt/C was better than that of the three-component mixed catalyst (Examples 7 to 8), and it appears to be the result of iridium and ruthenium failing to act as catalysts at low overvoltage, and thus, the content of the effective catalysts was lowered by the mixing ratio. In particular, Pt/C showed good performance even at a low content, because the surface area per unit mass of platinum was relatively larger than that of platinum.

A peculiar fact during the test is that water was supplied to the anode side and circulated to the oxygen-side water tank along with the generated oxygen through the outlet. In this case, it was discovered that a small fire caught on the generated oxygen and continued to burn in the water. When the operation of the stack was stopped, the fire went out, but when the operation was restarted, this phenomenon occurred again, and the test was prematurely terminated. In order to interpret this phenomenon, the amount of hydrogen generated on the cathode side was measured, but the exact amount of generation according to the current was measured, and thus, it did not appear to be a phenomenon due to the crossover of hydrogen through the electrolyte membrane, and it was presumed to be a phenomenon caused by the process in which hydrogen ions generated during the decomposition of water in the anode catalyst layer are reduced back to water by receiving oxygen generated nearby and electrons from the surface of the catalyst layer before moving to the electrolyte membrane.

Platinum is a catalyst in which the oxidation and reduction of hydrogen can occur very quickly, and it appears that considerable caution is required when used in the anode catalyst layer. Due to these results, the compositions of Examples 5 to 8, which were not excellent in economic feasibility and safety, were not adopted in the following additional examples.

### Examples 9 to 12

In order to optimize the anode catalyst layer of Example 3, which showed the most excellent test results in Experimental Example 1, the MEAs in which the anode catalyst layer was formed at various contents as shown in Table 2 below were manufactured in the same manner as in Example 3 above, based on the content of the iridium and ruthenium catalysts in the anode catalyst layer of 0.7 mg/cm².

In this case, the catalyst content in the anode catalyst layer was adjusted by changing the injection amount of the ink for anode catalyst to the release film during the preparation of the anode catalyst layer.

TABLE 2

| | Anode catalyst layer | | Cathode catalyst layer | |
|---|---|---|---|---|
| | | Content in | | Content in |
| | | catalyst layer | | catalyst layer |
| | Type of | (or loading | Type of | (or loading |
| | catalyst in | amount, | catalyst in | amount, |
| Example | catalyst layer | mg/cm²) | catalyst layer | mg/cm²) |
| 9 | Ir and Ru | 0.70 | Pt/C | Content of |
| 10 | (Weight ratio | 0.65 | (100 wt. %) | platinum in |
| 11 | of 1:1) | 0.60 | | catalyst |
| 12 | | 0.55 | | layer = 0.1 |

### Experimental Example 2

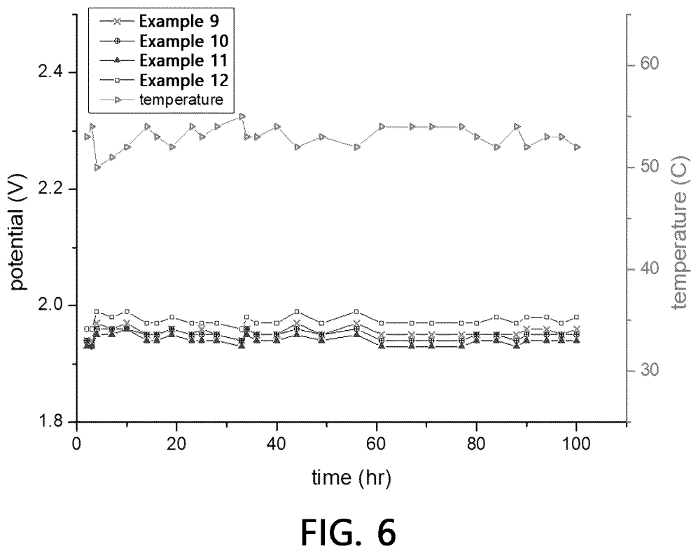

By using the MEAs of Examples 9 to 12, MEA stacks were manufactured in the same manner as in Experimental Example 1 above, and then performance and durability tests were performed in the same manner, and the results are shown in FIG. 6.

Referring to FIG. 6, the performance improved sequentially from Example 9 to Example 11, but there was a problem in that the overvoltage increased in Example 12. Through this, it was confirmed that it is relatively advantageous in terms of performance of the water electrolysis system, when the content of the catalyst (Ir+Ru catalyst) in the anode catalyst layer is 0.55 to 0.70 mg/cm², and preferably, 0.60 to 0.65 mg/cm².

### Examples 13 to 16

By applying the anode catalyst layer of Example 11, which showed the most excellent test results in Experimental Example 2, and for optimizing the cathode catalyst layer, MEAs were respectively manufactured by varying the platinum content in the cathode catalyst layer as shown in Table 3 below, and Examples 13 to 16 were carried out.

In this case, the Pt content in the cathode catalyst layer was adjusted by changing the injection amount of the ink for the cathode catalyst to the release film when each cathode catalyst layer was prepared in Examples 13 to 16.

TABLE 3

| | Anode catalyst layer | | Cathode catalyst layer | |
|---|---|---|---|---|
| | | Content in | | Content in |
| | | catalyst layer | | catalyst layer |
| | Type of | (or loading | Type of | (or loading |
| | catalyst in | amount, | catalyst in | amount, |
| Example | catalyst layer | mg/cm²) | catalyst layer | mg/cm²) |
| 13 | Ir and Ru | 0.60 | Pt/C | Content of Pt = 0.11 |
| 14 | (weight ratio | | (100 wt. %) | Content of Pt = 0.09 |
| 15 | of 1:1) | | | Content of Pt = 0.07 |
| 16 | | | | Content of Pt = 0.05 |

### Experimental Example 3

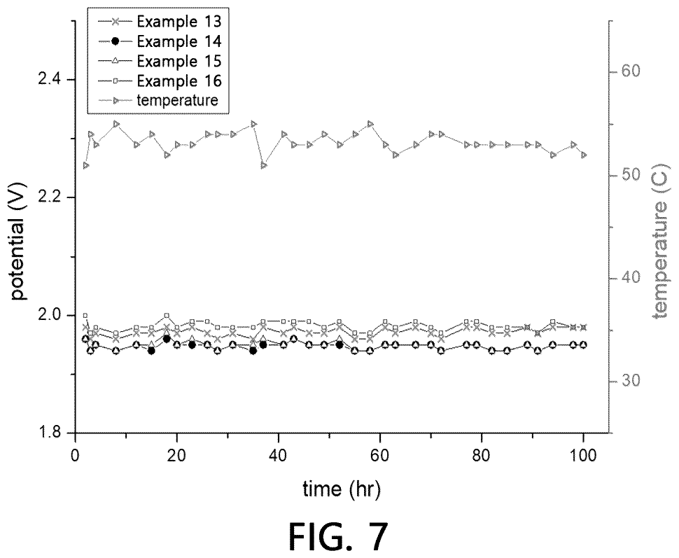

By using the MEAs of Examples 13 to 16, MEA stacks were manufactured in the same manner as in Experimental Example 1, and then performance and durability tests were performed in the same manner, and the results are shown in FIG. 7.

Referring to FIG. 7, each of Examples 13 and 16 showed a problem of high overvoltage due to excessive or insufficient platinum content in the catalyst layer.

On the other hand, Example 14 and Example 15 showed almost the same low overvoltage with appropriate contents.

Through this, it was confirmed that the desirable platinum content in the cathode catalyst layer is 0.06 to 0.10 mg/cm², preferably, 0.065 to 0.090 mg/cm², and more preferably, 0.070 to 0.085 mg/cm².

### Examples 17 to 20

As a two-component catalyst used in the anode catalyst layer, the anode catalyst ink and the film for forming an anode catalyst layer were respectively prepared by varying the mixing ratio of iridium and ruthenium as shown in Table 4 below in order to confirm the optimal mixing ratio of iridium and ruthenium, and the MEAs were respectively manufactured by using the same, and Examples 17 to 20 were carried out.

In this case, for the cathode catalyst layers of Examples 17 to 20, the MEAs were manufactured by using a cathode catalyst ink and a film for forming a cathode catalyst layer that were respectively prepared to have a platinum content of 0.08 mg/cm² between Examples 14 and 15.

TABLE 4

| | Anode catalyst layer | | Cathode catalyst layer | |
|---|---|---|---|---|
| | | Content in | | Content in |
| | | catalyst layer | | catalyst layer |
| | Type of | (or loading | Type of | (or loading |
| | catalyst in | amount, | catalyst in | amount, |
| Example | catalyst layer | mg/cm²) | catalyst layer | mg/cm²) |
| 17 | Ir:Ru = Weight | 0.60 | Pt/C | Content of |
| | ratio of 70:30 | | (100 wt. %) | Pt = 0.08 |
| | (=weight ratio | | | |
| | of 1:0.43) | | | |
| 18 | Ir:Ru = Weight | | | |
| | ratio of 50:50 | | | |
| | (=weight ratio | | | |
| | of 1:1) | | | |
| 19 | Ir:Ru = Weight | | | |
| | ratio of 30:70 | | | |
| | (=weight ratio | | | |
| | of 1:2.33) | | | |
| 20 | Ir:Ru = Weight | | | |
| | ratio of 10:90 | | | |
| | (=weight ratio | | | |
| | of 1:9) | | | |

### Experimental Example 4

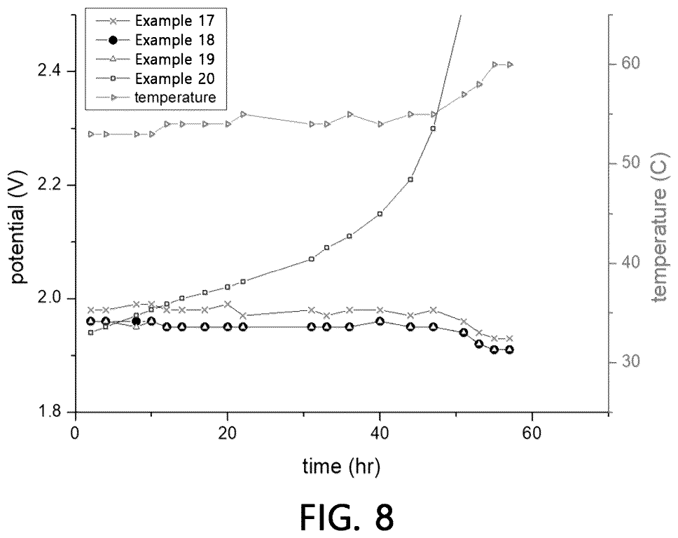

After manufacturing the MEA stacks in the same manner as in Experimental Example 1 using the MEAs of Examples 17 to 20, performance and durability tests were performed in the same manner, and the results are shown in FIG. 8.

Referring to FIG. 8, in the case of Example 17 having a high iridium content and a low ruthenium content, the overvoltage was relatively high, and Examples 18 and 19 in which the weight ratio of ruthenium was increased showed good performance with a low overvoltage.

However, when the mixing ratio of ruthenium was greatly increased as in Example 20, the best performance was shown at the start of operation, but the overvoltage soared within a few hours and became unusable, and the experiment was prematurely terminated due to this problem.

In general, 100% ruthenium-only catalyst is not used in the art due to the instability of ruthenium, and as can be confirmed in Example 20, when an excessive amount of ruthenium was included, it was confirmed that it was very unstable.

Ruthenium and its oxides go through several redox steps starting with bonding with water under the oxidation reaction condition of the anode to generate oxygen and return to their original state. Among these steps, particularly, there is a state of oxidation number with a high possibility of catalyst loss, and this state is stabilized by exchanging electrons with the surrounding iridium catalyst. Therefore, if the mixing ratio of ruthenium is too high such that ruthenium that cannot contact the surrounding iridium is generated, the possibility of its disappearance is very high. In particular, the results of Example 20 showed this phenomenon, and since the overvoltages of the two results were similar in Example 18 and Example 19, which showed the best results, if the performance is the same in terms of safety, it appears to be safe to select the one with the lower mixing ratio of ruthenium.

### Examples 21 to 24

Based on the measurement results in Table 4, the MEAs were manufactured by varying the mixing ratio of iridium and ruthenium in the anode catalyst layer as shown in Table 5 in order to more precisely specify the mixing ratio of iridium and ruthenium, and Examples 21 to 24 were carried out, respectively.

TABLE 5

| | Anode catalyst layer | | Cathode catalyst layer | |
|---|---|---|---|---|
| | | Content in | | Content in |
| | | catalyst layer | | catalyst layer |
| | Type of | or loading | Type of | (or loading |
| | catalyst in | (amount, | catalyst in | amount, |
| Example | catalyst layer | mg/cm²) | catalyst layer | mg/cm²) |
| 21 | Ir:Ru= Weight | 0.60 | Pt/C | Content of |
| | ratio of 50:50 | | (100 wt. %) | Pt = 0.08 |
| | (=weight ratio | | | |
| | of 1:1) | | | |
| 22 | Ir:Ru= Weight | | | |
| | ratio of 45:55 | | | |
| | (=weight ratio | | | |
| | of 1:1.22) | | | |
| 23 | Ir:Ru= Weight | | | |
| | ratio of 40:60 | | | |
| | (=weight ratio | | | |
| | of 1:1.50) | | | |
| 24 | Ir:Ru= Weight | | | |
| | ratio of 35:65 | | | |
| | (=weight ratio | | | |
| | of 1:1.86) | | | |

### Experimental Example 5: Long-Term Stability Test of Performance and Durability

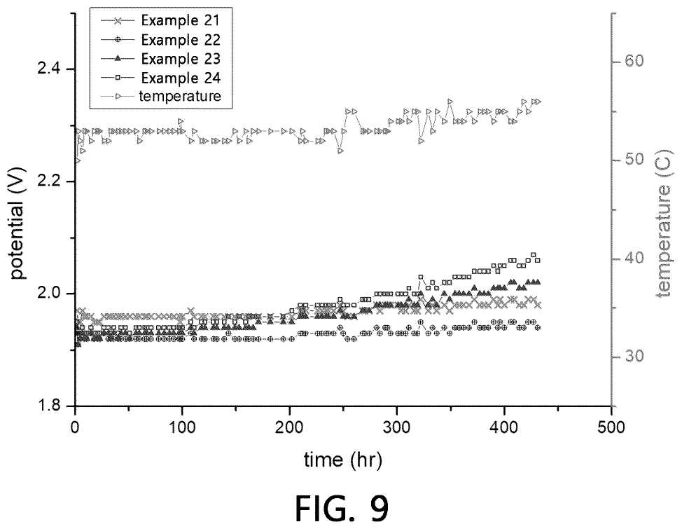

By using the MEAs of Examples 21 to 24, MEA stacks were manufactured in the same manner as in Experimental Example 1, and then, performance and durability tests were performed in the same manner for 431 hours, and the results are shown in FIG. 9.

Referring to FIG. 9, in the case of Example 22, in which the mixing ratio of ruthenium was increased, the performance was improved, and it showered a very low overvoltage, and the most excellent long-term performance stability and durability were shown.

Further, in the case of Examples 23 and 24, in which the mixing ratio of ruthenium was increased compared to Example 22, a problem that the performance was relatively deteriorated as time passed was observed, as compared with Example 22.

Example 19 (Ir:Ru=weight ratio of 30:70 weight ratio=weight ratio of 1:2.33) of FIG. 8 showed almost similar results to Example 18, but if a longer time test was performed as in Experimental Example 5, it can be inferred that performance degradation would have been observed. Referring to FIG. 9 including these results, Example 22, in which the mixing ratio of iridium and ruthenium was a weight ratio of 1:1.22, showed the most optimal performance.

Through FIGS. 8 and 9, in terms of securing durability and performance stability, it can be seen that it is optimal when the mixing ratio of iridium (Ir) and ruthenium (Ru) in the anode catalyst layer is a weight ratio of 1:0.80 to 1.40, preferably, a weight ratio of 1:0.90 to 1.35, and more preferably, a weight ratio of 1:1.10 to 1.30.

In commercial polymer electrolyte water electrolysis stacks that are generally used, 2 mg/cm² of iridium is generally used as a catalyst in the anode catalyst layer, and 0.4 mg/cm² of platinum is generally used in the cathode catalyst layer. Through the above examples and experimental examples, it was confirmed that the anode catalyst layer of the MEA of the present invention can reduce the catalyst content to about ⅓, and the cathode catalyst layer can reduce the platinum content to about ⅕.

The reason that the amounts of the noble metal catalysts can be greatly reduced while maintaining or further increasing the performance and durability as described above is considered to be because the three-dimensional mesh is supported by the physicochemically optimized composition of the catalyst layer.

1. A membrane-electrode assembly for a polymer electrolyte water electrolysis stack, wherein an anode electrode layer, an anode catalyst layer, a polymer solid electrolyte membrane, a cathode catalyst layer and a cathode electrode layer are sequentially stacked,
wherein the anode catalyst layer comprises a mixed catalyst comprising iridium and ruthenium at 0.50 to 0.90 mg/cm2, and
wherein the cathode catalyst layer comprises platinum at 0.06 to 0.10 mg/cm2.

2. The membrane-electrode assembly of claim 1, wherein the anode catalyst layer is coated on one surface of the polymer solid electrolyte membrane or one surface of the anode electrode layer, and
wherein the cathode catalyst layer is coated on one surface of the polymer solid electrolyte membrane or one surface of the cathode electrode layer.

3. The membrane-electrode assembly of claim 1, wherein the anode catalyst layer comprises iridium and ruthenium at a weight ratio of 1:0.40 to 2.40.

4. The membrane-electrode assembly according to claim 1, wherein in the polymer electrolyte water electrolysis stack, a flow path plate comprising a three-dimensional mesh is stacked on one surface of each of the anode electrode layer and the cathode electrode layer.

5. (canceled)

6. A method for manufacturing a membrane-electrode assembly for a polymer electrolyte water electrolysis stack, comprising:
step 1 of bonding a film for forming an anode catalyst layer to one surface of a polymer electrolyte membrane and bonding a film for forming a cathode catalyst layer to the other surface of the polymer electrolyte membrane;
step 2 of performing a pressing process under the conditions of 130 to 145° C. and 130 to 150 bar for the polymer electrolyte membrane performed in step 1 to transfer an anode catalyst layer to one surface of the polymer electrolyte membrane and transfer a cathode catalyst layer to the other surface of the polymer electrolyte membrane;
step 3 of removing release films on both surfaces from the polymer electrolyte membrane performed in step 2 to manufacture an assembly in which an anode catalyst layer, a polymer electrolyte membrane and a cathode catalyst layer are sequentially stacked; and
step 4 of respectively bonding electrodes to the upper portion of the anode catalyst layer and the upper portion of the cathode catalyst layer of the assembly, and then performing a pressing process,
wherein the anode catalyst layer comprises a mixed catalyst comprising iridium and ruthenium at 0.50 to 0.90 mg/cm2, and
wherein the cathode catalyst layer comprises platinum at 0.06 to 0.10 mg/cm2.

7. The method of claim 6, wherein the film for forming an anode catalyst layer is prepared by coating an anode catalyst ink on one surface of a release film, and then performing a first heat treatment at 95 to 110° C. for 50 to 120 minutes, followed by a second heat treatment at 120 to 140° C. for 20 to 40 minutes,
wherein the anode catalyst ink comprises 10 to 35 parts by weight of an ionomer and 4,500 to 5,500 parts by weight of a solvent, based on 100 parts by weight of a mixed powder comprising iridium powder and ruthenium powder, and
wherein the solvent comprises distilled water and isopropanol.

8. The method of claim 7, wherein the mixed powder comprises iridium and ruthenium at a weight ratio of 1:0.40 to 2.40.

9. The method of claim 6, wherein the film for forming a cathode catalyst layer is prepared by coating a cathode catalyst ink on one surface of a release film, and then performing a first heat treatment at 95 to 110° C. for 50 to 120 minutes, followed by a second heat treatment at 120 to 140° C. for 20 to 40 minutes,
wherein the cathode catalyst ink comprises 35 to 80 parts by weight of an ionomer and 4,500 to 5,500 parts by weight of a solvent, based on 100 parts by weight of amorphous carbon black comprising 15 to 25 wt. % of platinum, and
wherein the solvent comprises distilled water and isopropanol.

10. A method for manufacturing a membrane-electrode assembly for a polymer electrolyte water electrolysis stack, wherein after respectively preparing an anode electrode formed with an anode catalyst layer and a cathode electrode formed with a cathode catalyst layer, a process of respectively stacking and bonding the anode electrode and the cathode electrode to one surface of a polymer electrolyte membrane is performed,
wherein the anode electrode is prepared by applying an anode catalyst ink on one surface of the electrode and then performing heat treatment,
wherein the cathode electrode is prepared by applying a cathode catalyst ink on one surface of the electrode and then performing heat treatment,
wherein the anode catalyst layer comprises a mixed catalyst comprising iridium and ruthenium at 0.50 to 0.90 mg/cm2, and
wherein the cathode catalyst layer comprises platinum at 0.06 to 0.10 mg/cm2.

11. The method of claim 10, wherein the anode catalyst ink comprises 10 to 35 parts by weight of an ionomer and 4,500 to 5,500 parts by weight of a solvent, based on 100 parts by weight of a mixed powder comprising iridium powder and ruthenium powder, and
wherein the cathode catalyst ink comprises 35 to 80 parts by weight of an ionomer and 4,500 to 5,500 parts by weight of a solvent, based on 100 parts by weight of amorphous carbon black comprising 15 to 25 wt. % of platinum.
